(19) United States
(12) Patent Application Publication
(10) Pub. No.: US 2013/0108237 A1
(43) Pub. Date: May 2, 2013

(54) VIDEO PURCHASING METHOD, VIDEO PLAYING METHOD, SERVER AND VIDEO PLAYING DEVICE

(71) Applicants: Wei ZHANG, Hunan (CN); Dan LI, Heilongjiang (CN); Jian XU, Beijing (CN)

(72) Inventors: Wei ZHANG, Hunan (CN); Dan LI, Heilongjiang (CN); Jian XU, Beijing (CN)

(73) Assignee: SONY MOBILE COMMUNICATIONS AB, Lund (SE)

(21) Appl. No.: 13/613,866

(22) Filed: Sep. 13, 2012

(30) Foreign Application Priority Data
Oct. 28, 2011 (CN) 201110334839.5

(51) Int. Cl. G06Q 30/06; H04N 5/775

(52) U.S. Cl. 386/230; 705/26.5; 386/E05.07

(57) ABSTRACT

The present invention relates to a video purchasing method, a video playing method, a server and a video playing device. The video purchasing method comprises: receiving a request of a user for purchasing a video file, the request including starting time and ending time of part of the video contents in a complete video file selected by the user; determining starting frame and ending frame to which the starting time and the ending time correspond; and generating the video file to which the part of the video contents corresponds according to the starting frame and the ending frame. According to the method, the user may purchase video contents as needed, and need not purchase the whole video file, which not only brings convenience to users, but also saves costs.

### TECHNICAL FIELD

The present invention relates to the field of video technology, and in particular to a video purchasing method, a video playing method, a server and a video playing device.

### BACKGROUND ART

Currently, high-definition video contents are becoming more and more popular, and many video websites provide such high-definition video contents to users. However, in the implementation of the present invention, applicant found that some defects exist in the modes of purchasing, causing inconvenience to users when purchasing such contents. For example, a video file, such as high-definition video contents usually contains advertisements and when a user purchases high-definition video contents, he has to purchase the advertisements contained in video contents. Furthermore, the user needs to purchase the whole video file, and cannot purchase parts of the video file based on his preference.

### SUMMARY OF THE INVENTION

In addition, as 3D video multimedia is more and more popular, many users purchase 3D TV sets to enjoy video with the 3D effects. For example, for a Blue Ray 3D multimedia playing device produced by Sony, if the TV set supports 3D signals and the video input port as well as the connection cable is High Definition Multimedia Interface (HDMI) 1.3 or higher, the user may enjoy video with 3D effects. Otherwise, he may only enjoy video with 2D effects. However, in the implementation of the present invention, applicant found that the 3D videos provided by a provider cannot be efficiently protected, since the video contents are always illegally duplicated and used, and no effective solution regarding such an issue has been found yet.

The embodiments of the present invention provide a video purchasing method, a video playing method, a server and a video playing device, such that a user may purchase wanted video contents by frame.

According to an aspect of the embodiments of the present invention, there is provided a video purchasing method, the method including:

receiving a request of a user for purchasing a video file, the request including starting time and ending time of part of the video contents in a complete video file selected by the user;

determining starting frame and ending frame to which the starting time and the ending time correspond; and

generating the video file to which the part of the video contents corresponds according to the starting frame and the ending frame.

Preferably, the method further includes: generating corresponding authorization control information;

the authorization control information, further including the identification of the generated video file and the starting frame and the ending frame of the generated video file; or

the authorization control information, which further includes

the control information of the whole video file and the control information of the generated video file; wherein the control information of the generated video file includes: the identification of the generated video file, the starting frame and the ending frame of the generated video file and the following information: the type of the playing license of the generated video file ,limitation and the link information directed to the control information of the whole video file.

Preferably, before the step of receiving a request of a user for purchasing a video file, the method further includes:

configuring a complete video file with frame identifications and corresponding prices frame by frame;

the step of generating the video file to which the part of the video contents corresponds according to the starting frame and the ending frame includes:

generating the video file to which the part of the video contents corresponds according to the frame identifications in an increasing order to which the starting frame and the ending frame correspond.

Preferably, the method further includes:

providing the time information of the complete video file according to the request of the user, such that the user selects the starting time and the ending time of the part of the video contents according to the time information;

wherein the time information is a corresponding relationship between the played time and the price of the video file.

Preferably, after the step of receiving a request from a user for purchasing a video file, the method further includes:

judging whether the user has purchased other parts of the video contents of the complete video file;

adding the part of the video contents selected by the user to the video file to which the other parts of the video contents correspond, if the result of judgment is positive; and

updating the authorization control information.

Preferably, the video file is a 3D video file, and the authorization control information further includes identification information indicating whether a 3D effect can be played.

According to another aspect of the embodiments of the present invention, there is provided a video purchasing method, the method including:

acquiring time information of a complete video file, the time information being the corresponding relationship between the played time and the price of the video file; and

transmitting to a server a request for purchasing including the starting time and the ending time of part of video contents in the complete video file, selected by a user.

According to a further aspect of the embodiments of the present invention, there is provided a video playing method, the method including:

reading a video file, the video contents contained in the video file being part of video contents in a complete video file;

judging whether the video file has been purchased according to the video identification of the video file and pre-obtained authorization control information; wherein the authorization control information includes a video identification and the starting time and the ending time of the video file; and

transmitting video signals to a displaying unit if the result of judgment is positive, such that the displaying unit plays the video file.

Preferably, the video file is a 3D video file, and the authorization control information further includes identification information indicating whether a 3D effect can be played.

Before the step of transmitting video signals to the displaying unit, the method further includes:

judging whether authorization for playing 3D has been purchased; transmitting video signals to the displaying unit if the result of judgment is positive, such that the displaying unit plays the video with 3D effect; and transmitting video signals to the displaying unit if the result of judgment is negative, such that the displaying unit plays the video with 2D effect.

Preferably, before the step of judging whether authorization for playing 3D has been purchased, the method further includes:

judging whether the displaying unit supports 3D video; and

if the result of judgment is that the displaying unit supports 3D video, judging whether authorization for playing 3D has been purchased.

According to still another aspect of the embodiments of the present invention, there is provided a server, the server includes:

a first receiving unit, for receiving a request of a user for purchasing a video file, the request including the starting time and the ending time of part of the video contents in a complete video file selected by the user;

a first determining unit, for determining the starting frame and the ending frame to which the starting time and ending time correspond; and

a first generating unit, for generating the video file to which the part of the video contents corresponds according to the starting frame and the ending frame.

Preferably, the server further includes:

an information generating unit, for generating corresponding authorization control information, the authorization control information including the identification of the generated video file and the starting frame and the ending frame of the generated video file; or

the authorization control information including the control information of the whole video file and the control information of the generated video file; wherein the control information of the generated video file includes: the identification of the generated video file, the starting frame and the ending frame of the generated video file and the following information: the type of the playing license of the generated video file, the limitation and the link information directed to the control information of the whole video file.

Preferably, the server further includes:

an information configuring unit, for configuring a complete video file with frame identifications and corresponding prices frame by frame;

the first generating unit is specifically used for generating the video file to which the part of the video contents corresponds according to the frame identifications in an increasing order to which the starting frame and ending frame correspond.

Preferably, the server further includes:

an information providing unit, for providing the time information of the complete video file according to the request of the user, such that the user selects the starting time and the ending time of the part of the video contents according to the time information; wherein the time information is the corresponding relationship between the played time and the price of the video file.

Preferably, the server further includes:

a first judging unit, for judging whether the user has purchased other parts of the video contents of the complete video file;

a second generating unit, for adding the part of the video contents selected by the user to the video file to which the other parts of the video contents correspond, if the result of judgment of the first judging unit is positive; and

an information updating unit, for updating the authorization control information.

Preferably, the video file is a 3D video file, and the authorization control information further includes identification information indicating whether a 3D effect can be played.

According to still another aspect of the embodiments of the present invention, there is provided a client, the client includes:

a first information acquiring unit, for acquiring time information of a complete video file, the time information being corresponding relationship between the played time and price of the video file; and

a request transmitting unit, for transmitting to a server a request for purchasing, including the starting time and the ending time of part of video contents in the complete video file, selected by a user.

According to still another aspect of the embodiments of the present invention, there is provided a video playing device, the device including:

a first reading unit for reading a video file, the video contents contained in the video file being part of video contents in a complete video file;

a second judging unit for judging whether the video file has been purchased according to the video identification of the video file and pre-obtained authorization control information; wherein the authorization control information includes a video identification and the starting time and the ending time of the video file; and

a first transmitting unit for transmitting video signals to a displaying unit if the result of judgment of the second judging unit is positive, such that the displaying unit plays the video file.

Preferably, the device further includes a displaying unit for receiving the video signals transmitted by the transmitting unit and displaying corresponding video.

Preferably, the video file is a 3D video file, and the authorization control information further includes identification information indicating whether a 3D effect can be played.

The device further includes:

a third judging unit, for judging whether authorization for playing 3D has been purchased when the result of judgment of the second judging unit is positive;

and when the result of judgment of the third judging unit is positive, the first transmitting unit transmits video signals to the displaying unit, such that the displaying unit plays the video with 3D effect, and when the result of judgment of the third judging unit is negative, transmits video signals to the displaying unit, such that the displaying unit plays the video with 2D effect.

Preferably, the device further includes a fourth judging unit for, before the third judging unit judges whether authorization for playing 3D has been purchased, judging whether the displaying unit supports 3D video; and when the result of judgment is that the displaying unit supports 3D video, the third judging unit judges whether video with 3D effect can be played.

According to still another aspect of the embodiments of the present invention, there is provided a video playing method, the method including: reading a 3D video file;

judging whether authorization for playing 3D has been purchased according to the video identification of the 3D video file and pre-obtained authorization control information;

transmitting video signals to a displaying unit if the result of judgment is positive, such that the displaying unit displays the video with 3D effect; and transmitting video signals to the displaying unit if the result of judgment is negative, such that the displaying unit displays the video with 2D effect.

Preferably, after a playing device reads a 3D video file, the method further includes:

judging whether the displaying unit supports 3D video;

judging whether authorization for playing 3D has been purchased, if the result of judgment is that the displaying unit supports 3D video.

Preferably, the method further includes:

transmitting a request for purchasing the 3D video to a server via a network; and

receiving authorization control information returned by the server in response to the request, including the video identification of the 3D video file and identification information indicating whether a 3D effect can be played.

According to still another aspect of the embodiments of the present invention, there is provided a video playing device, the device includes:

a video reading unit, for reading a 3D video file;

a first detecting unit, for judging whether authorization for playing 3D has been purchased according to the video identification of the 3D video file and pre-obtained authorization control information; and

a second transmitting unit, for transmitting video signals to a displaying unit if the result of judgment of the first detecting unit is positive, such that the displaying unit displays the video with 3D effect; and transmitting video signals to the displaying unit if the result of judgment is negative, such that the displaying unit displays the video with 2D effect.

Preferably, the device further includes a displaying unit for displaying video with 3D effect or 2D effect according to the video signals transmitted by the second transmitting unit.

Preferably, the device further includes:

a second detecting unit, for judging whether the displaying unit supports 3D video;

the first detecting unit, judges whether authorization for playing 3D has been purchased when the result of the second detecting unit is that the displaying unit supports 3D video.

Preferably, the device further includes:

a request transmitting unit, for transmitting a request for purchasing the 3D video to a server via a network; and

an information acquiring unit for acquiring authorization control information returned by the server in response to the request, including the video identification of the 3D video file and identification information indicating whether a 3D effect can be played.

According to still another aspect of the embodiments of the present invention, there is provided a video purchasing method, the method including:

receiving a request of a user for purchasing a 3D video file;

generating, after the user purchases the 3D video file, authorization control information including identification information indicating that 3D effect can be played; and

transmitting the authorization control information to a playing device.

According to still another aspect of the embodiments of the present invention, there is provided a server, the server including:

a second receiving unit, for receiving a request of a user for purchasing a 3D video file;

a second generating unit, for generating, after the user purchases the 3D video file, authorization control information including video identification and identification information indicating that 3D effect can be played; and an information transmitting unit, for transmitting the authorization control information to a playing device.

Advantages of the embodiments of the present invention exist in that a user may select the starting time and the ending time of part of video contents, and a server determines the starting frame and the ending frame to which the starting time and the ending time correspond according to the corresponding relationship between the played time and the frames, and generates a video file between the starting frame and the ending frame. In this way, the user only needs to purchase part of video contents of a whole video file, and does not purchase the contents that are not needed, which not only brings convenience to users, but also saves corresponding costs.

Many aspects of the invention can be better understood with reference to the following drawings. Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment.

### BRIEF DESCRIPTION OF THE DRAWINGS

The drawings are included to provide further understanding of the present invention, which constitute a part of the specification and illustrate the preferred embodiments of the present invention, and are used for setting forth the principles of the present invention together with the description. The drawings described below are merely some embodiments of the present invention, and according to these drawings, other drawings may be obtained by those skilled in the art without making an inventive effort.

FIG. 1 is a flowchart of the video purchasing method in accordance with embodiment 1 of the present invention;

FIG. 2 is a schematic diagram showing the relationship between the time and price of a video file in accordance with embodiment 1 of the present invention;

FIG. 3 is a flowchart of the video purchasing method in accordance with embodiment 2 of the present invention;

FIG. 4 is a flowchart of the video purchasing method in accordance with embodiment 3 of the present invention; FIG. 5 is a flowchart of the video playing method in accordance with embodiment 4 of the present invention;

FIG. 6 is a flowchart of the video playing method in accordance with embodiment 5 of the present invention;

FIG. 7 is a schematic diagram of the structure of the server in accordance with embodiment 6 of the present invention;

FIG. 8 is a schematic diagram of the structure of the server in accordance with embodiment 7 of the present invention;

FIG. 9 is a schematic diagram of the structure of the server in accordance with embodiment 8 of the present invention;

FIG. 10 is a schematic diagram of the structure of the client in accordance with embodiment 9 of the present invention;

FIG. 11 is a schematic diagram of the structure of the video playing device in accordance with embodiment 10 of the present invention;

FIG. 12 is a schematic diagram of the structure of the video playing device in accordance with embodiment 11 of the present invention;

FIG. 13 is a schematic diagram of the structure of the video playing device in accordance with embodiment 12 of the present invention;

FIG. 14 is a flowchart of the video playing method in accordance with embodiment 13 of the present invention;

FIG. 15 is a schematic diagram of the structure of the video playing device in accordance with embodiment 14 of the present invention;

FIG. 16 is a flowchart of the video purchasing method in accordance with embodiment 15 of the present invention;

FIG. 17 is a schematic diagram of the structure of the server in accordance with embodiment 16 of the present invention.

### DETAILED DESCRIPTION OF EMBODIMENTS

The particular embodiments of the present invention are described as follows with reference to the drawings. In the description below, details are described for the purpose of explanation, so as to help understanding the present invention, however, they are limited thereto. It is obvious to those skilled in the art that the present invention may be carried out in other embodiments departing from these details.

It should be noted that in order to avoid ambiguity of the present invention by unnecessary particulars, structures of devices and/or processing steps closely related to the solution of the present invention are only shown in the drawings, with those particulars not closely related to the solution of the present invention being omitted.

In the prior art, providers usually provide a whole video file to users, and the users need to purchase the whole video file in purchasing the video file, which may contain advertisements that they do not hope to watch. Thus, users cannot purchase videos on their own will, bringing much inconvenience to the users. Therefore, in the embodiments of the present invention, a provider identifies a video file in accordance with frames, such that a user may select the wanted video contents on his own will, without needing to purchase a whole video file. The embodiments of the present invention will be described below with reference to the drawings.

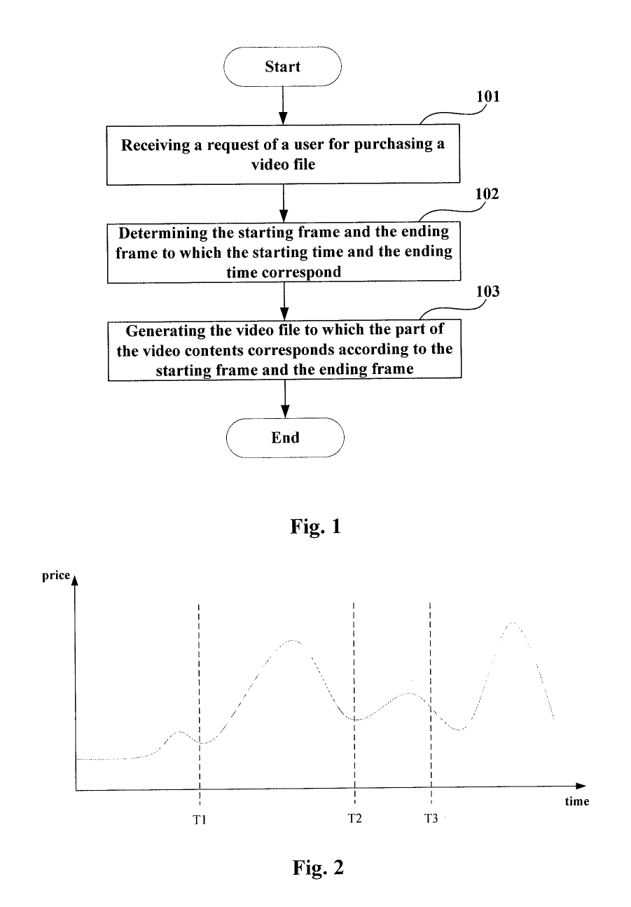

FIG. 1 is a flowchart of the video purchasing method in accordance with embodiment 1 of the present invention. As shown in FIG. 1, the method includes:

step 101: receiving a request for purchasing a video file from a user, the request including starting time and ending time of part of the video contents in a complete video file selected by the user;

step 102: determining starting frame and ending frame to which the starting time and the ending time correspond; and

step 103: generating the video file to which the part of the video contents corresponds according to the starting frame and the ending frame.

It can be seen from the above embodiment that the user may purchase the video contents he wants, without needing to purchase the whole video file, bringing convenience to users, and avoiding unnecessary costs.

In this embodiment, a server provided by a provider may be used for purchasing video. The user may use a client to remotely purchase video via a network, and may also purchase video at a business site of the provider.

In this embodiment, a preparing step may be included before step 101: configuring a complete video file with frame identifications frame by frame in advance, so that the starting frame and the ending frame may be used to denote the purchased part of video contents. In addition, a price corresponding to a frame may also be configured, so that when the user selects the part of video contents, he may obtain the cost of the part of video contents according to the configured price, facilitating the user to make payment. The corresponding relationship between the configured frame identification and the price may be stored in the server. For example, frame identifications may be configured in a playing order from front to back, with each frame or several frames being configured with the identification, and the corresponding price.

Furthermore, when the specifications of a video file, such as frame rate, are determined, the corresponding relationship between the frames of the video file and the time is known. In step 102, the above information of the video file may be used to determine the starting frame and the ending frame to which the starting time and the ending time correspond. For example, the frame rate may be 24 frames/second, 30 frames/second, or 50 frames/second. If the frame rate is 30 frames/second, when the video contents from T1=30 seconds to T2=50 seconds are selected by the user, the corresponding video contents from the 901^{th} (T1×frame rate+1=30×30+1) frame to the 1500^{th} ( T2×frame rate=1500) frame are selected. In this embodiment, the corresponding relationship between the played time of the video file and the price is used to indicate the relationship between the frames and the price, which is shown with graphs, as illustrated in FIG. 2. However, it is not limited to graphs; tables and other forms such may be used, which shall not be described any further.

When a server is used to purchase video by a user, the server may provide the time information of a complete video file upon the request of the user, the time information being the corresponding relationship between the played time of the video file and the price. For example, the graph of FIG. 2 is provided herein for a user to select the starting time (T1) and the ending time (T2) with reference to the time information shown in FIG. 2. In addition, while the user selects the starting time (T1) and the ending time (T2), the graph of FIG. 2 may visually show the prices of every parts of the video and after the user selects a part of the video contents, the server may accumulate the corresponding prices of each of the frames within this time period, so as to obtain the cost of the part of video contents purchased by the user, and the user may make payment on the basis of such a cost.

After the user selects the starting time (T1) and the ending time (T2), in step 101, the server may obtain the starting time (T1) and the ending time (T2). In step 102, the server may determine the starting frame and the ending frame to which the starting time (T1) and the ending time (T2) correspond according to the corresponding relationship between the time and the frames. Furthermore, the cost of the video contents within this period may also be learnt. After the user makes payment, in step 103, the server may combine the video contents between the starting frame and the ending frame in an order from front to back, so as to generate a video file. In addition, after the server generates the video file, the method further includes: generating corresponding authorization control information, wherein the authorization control information includes the identification of the video file and the starting frame and the ending frame of the generated video file to which the generated video contents correspond. The authorization control information may be in an XML format; however, it is not limited thereto, and other formats may be used. The authorization control information further includes, in addition to the above information, other authority information, such as times of playing the video file, and terms for playing the video file, etc., which is similar to the prior art and shall not be described any further.

In this embodiment, when the user purchases video contents by using a client via a network, the server provides the graph shown in FIG. 2 to the client upon the request of the user and displays the graph on the displaying interface of the client. The user may select the starting time and the ending time via the input device of the client, and notify the server the selected starting time and ending time. After the server generates the video file, it may transmit the video file to the client of the user via the network, and may also transmit the generated authorization control information to the client via the network, for use in playing the video file.

In this embodiment, after step 101, if the user also purchases another part of the video file, such as the part of the video file between T2 and T3, the server may add the part of the video file between T1 and T2 to the other part of the video file (the part of the video file between T2 and T3), so as to form a video file. Thus, the method further includes: judging whether the user has purchased other parts of the video contents of the complete video file; adding the part of the video contents selected by the user to the video file to which the other parts of the video contents correspond, if the result of judgment is positive. In addition, the authorization control information should be updated. For example, the starting time T2 of the video contents between T2 and T3 is updated as T1, with the ending time being unchanged.

In this embodiment, the video file purchased by the user may be a 3D video file, and the authorization control information may further include identification information indicating whether 3D effect may be played. In order to watch 3D video effect, the user needs to purchase the authorization for playing the 3D effect; and if the user purchases the authorization for playing the 3D effect, the identification information is the identification information indicating that 3D effect may be played, otherwise, it is the identification information indicating that 3D effect may not be played, or the identification information indicating that 2D effect may be played. For example, if the user pays relevant fee to purchase the authorization for playing the 3D video, the identification information is “1”, which indicates that 3D effect may be played; otherwise, the identification information is “0”, indicating that only 2D effect may be played. Of course, the identification information may be expressed in any other modes.

In the above embodiment, the user may purchase video contents via the server; however, it is not limited thereto, and the user may use any client, for example, a portable device, such as a mobile phone, and a notebook computer, etc., to browse the time information of the video file provided by the provider, then select the video contents within a certain period according to the time information, and transmit the request for purchasing to the server.

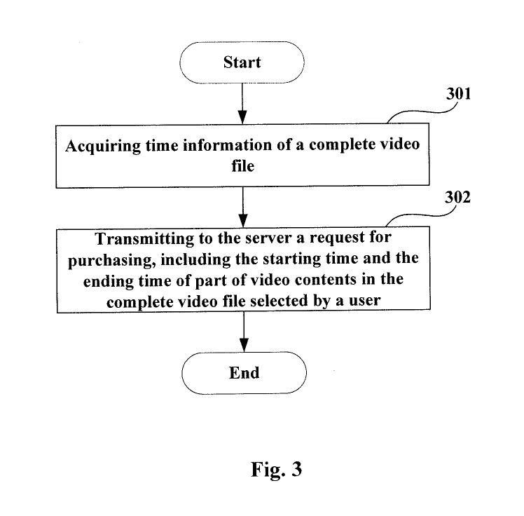

FIG. 3 is a flowchart of the video purchasing method in accordance with embodiment 2 of the present invention. As shown in FIG. 3, the method includes:

step 301: acquiring time information of a complete video file, the time information being the corresponding relationship between the played time and the price of the video file;

wherein, the user transmits a request for acquiring time information to the server, via a browser of the client, the server provides the time information to the client according to the request, and as shown in FIG. 2, the user may use the time information to select needed video contents; and

step 302: transmitting to the server a purchasing request including the starting time and the ending time of part of video contents in the complete video file selected by a user.

Furthermore, the method further includes: receiving the video file and the authorization control information returned by the server according to the purchasing request, and storing the video file and the authorization control information. The authorization control information is the same as described in embodiment 1, and shall not be described any further.

The video purchasing method of the embodiments of the present invention shall be described below taking that the user purchases a video file via a client as an example.

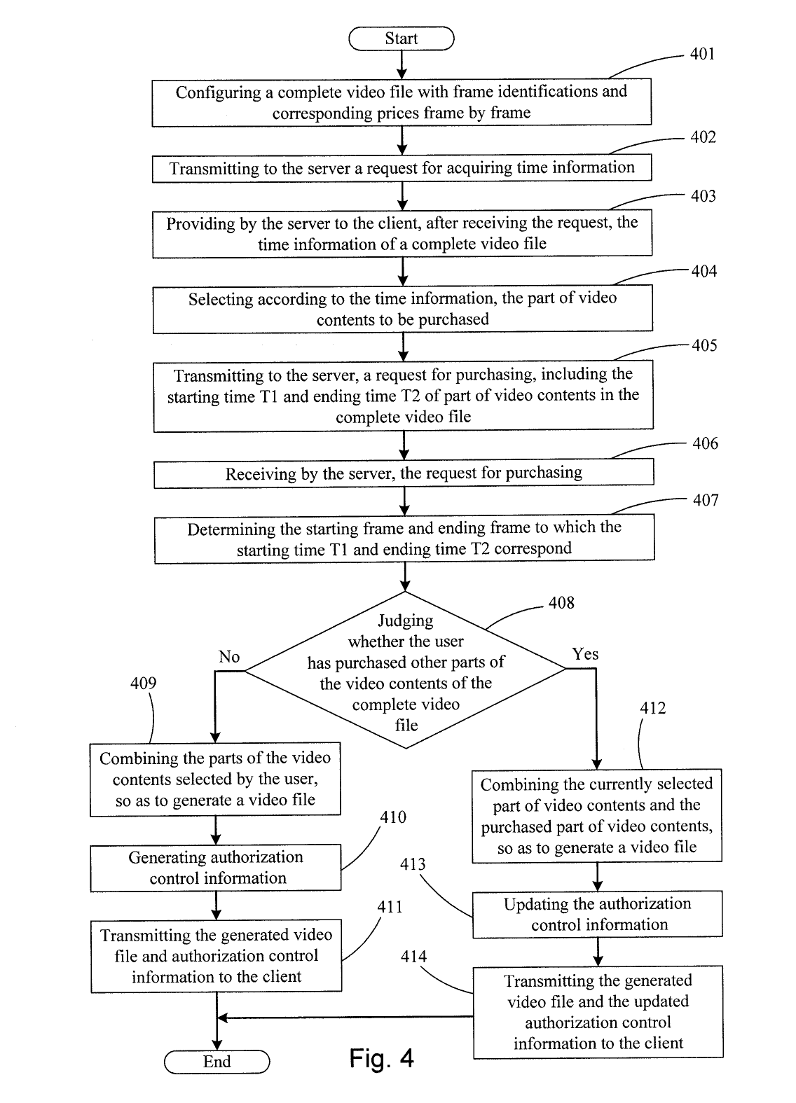

FIG. 4 is a flowchart of the video purchasing method in accordance with embodiment 3 of the present invention. As shown in FIG. 4, the method includes:

step 401: a preparing step, configuring a complete video file with frame identifications, frame by frame and configuring prices to which the frame corresponds at a server side, and storing the corresponding relationship between the frames and the prices in the server.

In this embodiment, the corresponding relationship between the frames and the prices are referred to as time information of the video file. The frame identifications may be configured in a playing order from front to back, with each frame or several frames being configured with an identification, and a corresponding price. For example, in this embodiment, each frame is configured with an identification and a corresponding price.

Step 402: transmitting to the server, by the user, via a browser of the client, a request for acquiring time information.

Step 403: providing by the server to the client, after receiving the request, the time information of a complete video file, and displaying the video file on the displaying unit of the client.

In this embodiment, the time information is shown in the manner as illustrated in FIG. 2, such that the user may select needed video contents by using the time information.

Step 404: selecting by the user according to the time information, the part of video contents to be purchased, i.e. the starting time and the ending time of the part of video contents.

In this embodiment, for example, the starting time T1 selected by the user is 30 seconds, and the ending time is 45 second. While the user selects the video contents, he may also see the corresponding price, such that the user learns conveniently the cost needed by the video contents to be purchased.

Step 405: transmitting by the client to the server, a purchasing request, including the starting time T1 and the ending time T2 of part of the video contents in the complete video file.

Step 406: receiving by the server, the purchasing request.

Step 407: determining by the server, the starting frame and the ending frame to which the starting time T1 and the ending time T2 correspond.

If the specifications of a video file, such as the frame rate, are determined, the corresponding relationship between the frames of the video file and the time is known.

In this embodiment, for example, when the frame rate is 60 frames/second and the user selects the video contents between the 30th second and the 45th second, the server may use the frame rate to learn the video contents from the 1801th frame to the 2700th frame, with the corresponding frame identifications including 000000001081, 000000001082, 000000001083, . . . , 000000002700.

In addition, the server may calculate the corresponding cost, i.e. the accumulated value of the cost for each frame from the 1801th frame to the 2700th frame, that is,

$$S = {\sum }_{i = 1081}^{2700} {s}_{i} ;$$

where, S denotes the cost of the video contents from the 1801th frame to the 2700th frame, sᵢ denotes the cost of each frame from the 1801th frame to the 2700th frame.

Step 408: judging, by the server, whether the user has purchased other parts of the video contents of the complete video file and executing step 409 if the result of judgment is positive; otherwise, executing step 412.

In this embodiment, the judgment is performed as follows: looking up, in the authorization control information recorded by the server, whether there exists frame identifications to which the starting frame and the ending frame of other parts of the video contents correspond. If positive, then it is judged that the user has purchased other parts of the video contents of the complete video file.

For example, if the user has purchased the part of video contents from T2=45th second to T3=60th second, i.e. the part of video contents between the 45th second and the 60th second, the frame identifications between the 2710th frame and the 3600th frame, i.e. 000000002701 and 000000003600, are recorded in the server.

Step 409: combining, by the server, the parts of the video contents selected by the user, so as to generate a video file, if the result of judgment is that the user has not purchased other parts of the video contents of the complete video file in step 408.

In this embodiment, the video file is synthesized in an order of the frame identifications from small to large, such as synthesizing the video file in an order 000000001081, 000000001082, 000000001083, . . . , 000000002700, of the frame identifications.

Step 410: generating authorization control information.

In this embodiment, the generated authorization control information may include information of two layers.

The first layer is the control information of the whole video file, referred to as a parent authorization, which, in addition to the identifications of the whole video, includes the following information: the identification, the price and valid time of the authorization information file, whether purchase is permitted, and whether purchase in a discretely recombining manner is permitted, etc.

The second layer is the control information of the part of the video contents purchased by the user, referred to as a child authorization, which inherits parent authorization and adds the following information on the basis of the parent authorization: the identification of the child authorization file, and time period information (i.e. the starting time and the ending time). In addition, the valid time information that is not beyond the parent authorization, the type (played for a period of time, or played for certain times, etc.) of the playing license of the part of the video contents, the limitation and the link information directed to the parent authorization, may also be included.

It can be seen from above that the authorization control information includes the information of two layers. The whole video file may be conveniently found via the first layer control information, and the user may conveniently add information on the purchase part of video contents via the second layer control information.

Step 411: transmitting, by the server, the video file generated in step 409 and the authorization control information generated in step 410, to the client.

Step 412: combining, by the server, the currently selected part of video contents and the purchased part of video contents, so as to generate a video file, if the result of judgment is that the user has purchased other parts of the video contents of the complete video file in step 408.

In this embodiment, for example, the part of video contents from the 1801th frame to the 3600th frame is combined into a video file, with the cost being that of the part of video contents from the 1801th frame to the 2700th frame.

Furthermore, if some of the currently purchased part of video contents has been purchased, the cost of the purchased part will be subtracted by the server in calculating the cost, thereby reducing the cost of the user.

Step 413: updating, by the server, the authorization control information. In this embodiment, for example, the starting time T2 of the part of video contents between T2 and T3 is updated as T1, with the ending time T3 being unchanged. Other information contained in the authorization control information may be unchanged, or may be updated as actually demanded; and

Step 414: transmitting, by the server, the video file generated in step 412 and the authorization control information updated in step 413, to the client.

In this way, after obtaining the video file and the authorization control information, the client may use the authorization control information to play the video file.

In this embodiment, if the above purchased video file is a 3D video file, the user needs to purchase the authorization for playing 3D. If the user purchases the authorization for playing 3D, the authorization control information may further include identification information indicating that a 3D effect can be played; otherwise, it may include identification information indicating that a 3D effect cannot be played or a 2D effect can be played. The step of purchasing the authorization for playing 3D may be prior to the step of generating the authorization control information or updating the authorization control information.

The above embodiment is described taking that the user purchases a video file via a client as an example. In addition, the user may also purchase a video file directly at a business site of the video provider. If so, a request for displaying time information and a request for purchasing a video file may be directly transmitted to the server. After the server generates a video file and authorization control information according to the request for purchasing a video file, it may still transmit the video file and the authorization control information to the client of the user via a network or may store the video file and authorization control information in a compact disk, such that the user may play the video file via a playing device.

It can be seen from the above embodiment that the user selects video contents of a certain time period according to the time information provided by the server and transmits the request for purchasing a video file to the server. The server may generate a video file of this time period according to the request for purchasing a video file. In this way, the user need not purchase the whole video file, which not only saves cost, but also avoids watching unneeded video contents.

Furthermore, the authorization control information may include control information of two layers. One layer being the control information of the whole video file, and other layer being the control information of the purchased part of video contents, thereby, facilitating the user in finding and adding the video file.

FIG. 5 is a flowchart of the video playing method in accordance with embodiment 4 of the present invention. As shown in FIG. 5, the method includes:

Step 501: reading a video file, the video contents contained in the video file being part of video contents in a complete video file.

Step 502: judging whether the video file has been purchased according to the video identification of the video file and pre-obtained authorization control information; wherein the authorization control information includes a video identification and the starting time and ending time of the video file; if the result of judgment is positive, executing step 503, otherwise, terminating the process.

In this embodiment, whether there exists information in the authorization control information to which the video identification corresponds may be found according to the video identification of the video file, and it may be determined that the video file has been purchased, if there exists information to which the video identification corresponds, otherwise, it may be determined that the video file has not been purchased.

In this embodiment, the authorization control information includes, in addition to the above information, other information as described in embodiment 3, which shall not be described any further.

Step 503: transmitting video signals to a displaying unit, if the result of judgment in step 502 is positive, such that the displaying unit plays the video file.

It can be seen from the above embodiment that the user may purchase part of video contents as needed, and when the user plays the video contents by using a playing device, the playing device may judge whether to play the video file according to the authorization control information, such that the user may not copy the video file at random, protecting the interests of the video provider.

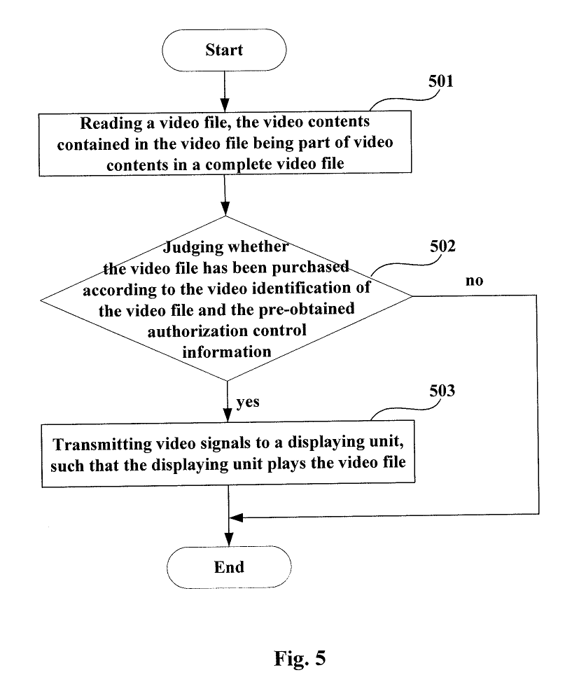

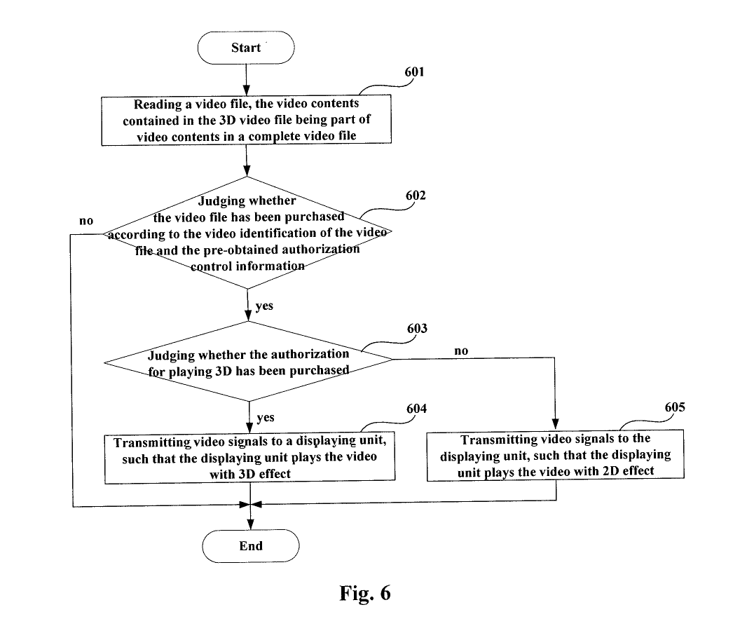

FIG. 6 is a flowchart of the video playing method in accordance with embodiment 5 of the present invention. The video file may be a 3D video file. If the user has purchased authorization for playing 3D, the authorization control information further includes identification information indicating that 3D effect may be played; otherwise, the authorization control information further includes identification information indicating that 3D effect may not be played or 2D effect may be played.

As shown in FIG. 6, the method includes:

Step 601: reading a 3D video file, the video contents contained in the 3D video file being part of video contents in a complete video file.

Step 602: judging whether the video file has been purchased according to the video identification of the video file and pre-obtained authorization control information; wherein the authorization control information includes a video identification and the starting time and the ending time of the video file; if the result of judgment is positive, executing step 603, otherwise, terminating the process.

Step 603: judging whether the authorization for playing 3D has been purchased according to the authorization control information;

wherein, judgment is performed according to the identification information in the authorization control information, and if the authorization control information includes identification information indicating that 3D effect may be played, it means that the authorization for playing 3D has been purchased, otherwise, the authorization for playing 3D has not been purchased, which is the same as described above, and shall not be described any further.

Step 604: transmitting video signals to a displaying unit, if the result of judgment in step 603 is positive, such that the displaying unit plays the video with 3D effect.

Step 605: transmitting video signals to the displaying unit, if the result of judgment in step 603 is negative, such that the displaying unit plays the video with 2D effect.

In this embodiment, before step 603, the method further includes: judging whether the displaying unit supports 3D video and if the result of judgment is that the displaying unit supports 3D video, executing step 603. Otherwise, if the displaying unit does not support 3D video, transmitting video signals to the displaying unit, such that the displaying unit plays the video with 2D effect. This step may be omitted if the playing device learns in advance that the displaying unit may play 3D video.

It can be seen from the above embodiment that the video file may be configured with frame identifications and with corresponding prices frame by frame in advance, and the user may select the part of video contents to be purchased according to the information on the time and price of the video file, and does not purchase unneeded contents, which not only provides convenience to users, but also saves corresponding costs.

After the user purchased video file, the corresponding authorization control information may be generated. The authorization control information may include contents of two layers, one layer being the control information of the whole video file, and other layer being the control information of the part of video contents purchased by the user. Thus, when the user needs to purchase more, he may first find the original file according to the first layer information, and then adds video contents according to the second layer information, thereby facilitating the user in purchasing a video file.

After the user purchases the part of video contents, the part of video contents may be played on a playing device. The playing device may be any apparatuses having a function of playing videos, such as a computer, a notebook computer, a mobile phone, and a DVD, etc. The playing device may or may not have a displaying unit.

The above flowcharts are merely illustrative and descriptive, and the methods according to the embodiments of the present invention are unnecessary to include each of the steps above, and some of the steps may be omitted, combined or inversed in order. The methods according to the embodiments of the present invention are not limited to being executed in the time order as described in the description, and may be sequentially, parallelly or independently executed in an temporal manner. Such variants shall be included in the scope of the present invention, if they are not departed from the spirit and scope of the present invention.

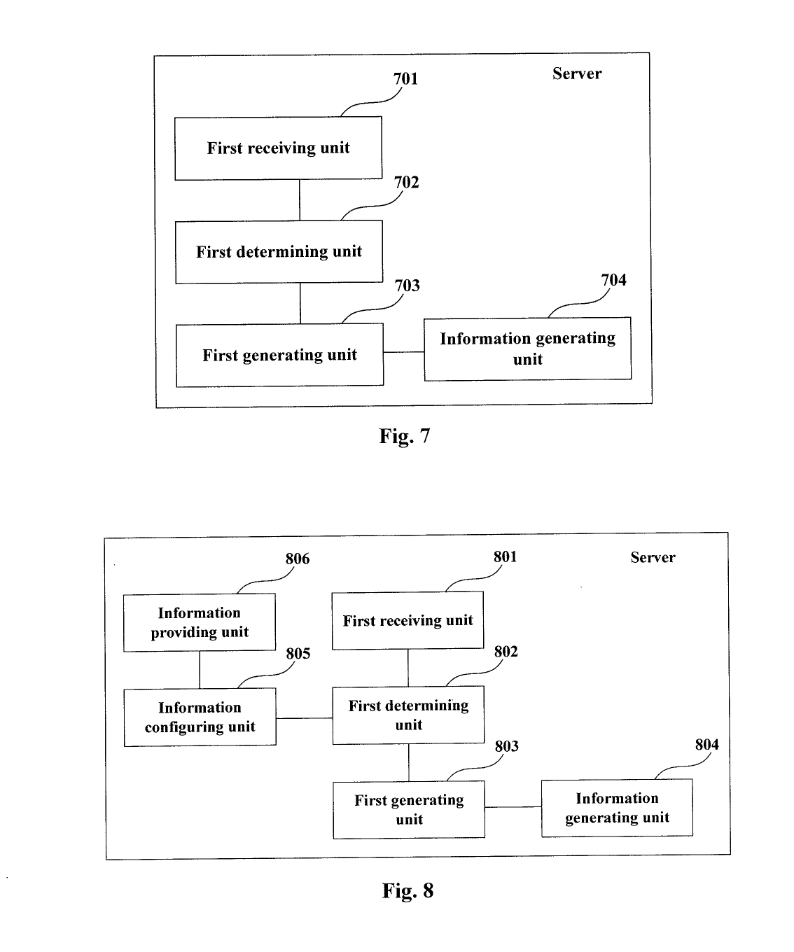

FIG. 7 is a schematic diagram of the structure of the server in accordance with embodiment 6 of the present invention. As shown in FIG. 7, the server includes: a first receiving unit 701, a first determining unit 702, and a first generating unit 703. The first receiving unit 701 is used for receiving a request of a user for purchasing a video file; the request includes the starting time and the ending time of part of the video contents in a complete video file selected by the user. The first determining unit 702 is used for determining the starting frame and the ending frame to which the starting time and the ending time correspond. The first generating unit 703 is used for generating the video file to which the part of the video contents corresponds according to the starting frame and the ending frame.

In this embodiment, the operational process of the server is as shown in FIG. 1, which shall not be described any further.

It can be seen from the above embodiment that the user may purchase part of video contents of a whole video file as needed, and does not purchase unneeded contents, which not only provides convenience to users, but also saves corresponding costs.

Furthermore, as shown in FIG. 7, the server includes an information generating unit 704, for generating corresponding authorization control information after the user makes payment. The authorization control information includes the identification of the generated video file and the starting frame and the ending frame of the video file to which the generated part of video contents corresponds, and other information as described in embodiment 3, which shall not be described any further.

FIG. 8 is a schematic diagram of the structure of the server in accordance with embodiment 7 of the present invention. As shown in FIG. 8, the server includes a first receiving unit 801, a first determining unit 802, a first generating unit 803, and an information generating unit 804, with the functions of which being similar to those described in embodiment 6, which shall not be described any further.

As shown in FIG. 8, the server further includes an information configuring unit 805, for configuring a complete video file with frame identification and a corresponding price frame by frame. The frame identification may be configured in an incremental manner according to the order of playing; for example, frame identification: XXXXXXXX01, price: 0.00000001 dollar; frame identification: XXXXXXXX02, price: 0.00000001 dollar, and so on.

Furthermore, the server includes a storing unit (not shown), for storing the corresponding relationship between the above frames and the prices, and for storing the generated authorization control information. In this embodiment, since the relationship between the frames and the time is definite in case of certain specifications of the video file, corresponding relationship between the time and the prices may be stored, as shown in FIG. 2. In such a case, the first generating unit 803 is specifically used for, according to the frame identifications to which the starting frame and the ending frame determined by the first determining unit 802 correspond, generating the video file in an increasing order to which the part of video contents corresponds.

As shown in FIG. 8, the server further includes an information providing unit 806, for providing the time information of the complete video file upon request by the user, such that the user selects the starting time and the ending time of the part of video contents according to the time information, wherein, the time information is the corresponding relationship between the played time and the price of the video file.

It can be seen from the above embodiment that the user may select the starting time and the ending time of the part of video contents according to the time information to which a video file provided by the provider corresponds, determine the starting frame and the ending frame to which the starting time and the ending time correspond according to the corresponding relationship between the played time and the frames, and generate the video file whose play time is between the starting time and the ending time in an increasing order of the frame identifications. In this way, the user may only purchase part of video contents of a whole video file, and does not purchase unneeded contents, which not only provides convenience to users, but also saves corresponding costs.

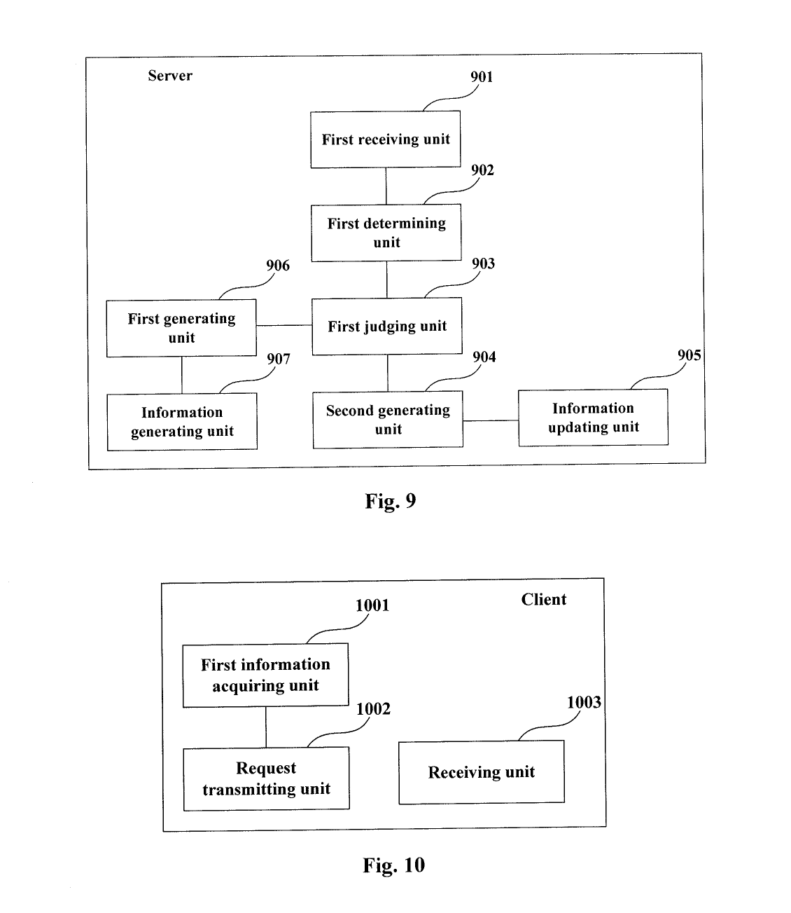

FIG. 9 is a schematic diagram of the structure of the server in accordance with embodiment 8 of the present invention. As shown in FIG. 9, the server includes a first receiving unit 901 and a first determining unit 902, with the functions of which being similar to those described in embodiments 6 and 7, which shall not be described any further.

As shown in FIG. 9, the server further includes a first judging unit 903, a second generating unit 904, and an information updating unit 905.

The first judging unit 903 is used for judging whether the user has purchased other part of the video contents of the complete video file, wherein the authorization control information to which the video file corresponds may be searched for, and if the authorization control information is found, it is further determined whether the authorization control information included the starting time and the ending time of the other part of video contents. If the starting time and the ending time of the other parts of video contents are included, it can be determined that the user has purchased the other part of the video contents of the complete video file.

The second generating unit 904 is used for adding the part of the video contents selected by the user to the video file to which the other part of the video contents corresponds, if the result of judgment of the first judging unit 903 is positive; and the information updating unit 905 is used for updating the authorization control information. The authorization control information to which the original other part of video contents corresponds may be updated as the authorization control information to which both the original other part of video contents and the current part of video contents correspond.

As shown in FIG. 9, a first generating unit 906 generates the video file to which the part of video contents corresponds according to the starting frame and the ending frame determined by the first determining unit 902, if the result of judgment of the first judging unit 903 is negative. The function of an information generating unit 907 is similar to that of the information generating unit of the above embodiment, which shall not be described any further.

In the above embodiment, the video file may be a 3D video file, and the authorization control information further includes identification information indicating whether a 3D effect can be played. Thus, in the embodiments shown in FIGS. 7-9, the user may further transmit a request to the server for purchasing authorization for playing 3D, and after the user makes payment, the authorization control information generated by the information generating units 704, 804, 907 and 905 may further include the above identification information.

The embodiments shown in FIGS. 7-9 are merely preferred embodiments of the present invention; however, the present invention is not limited thereto. The elements shown in FIGS. 7-9 may be combined randomly as actually demanded, for example, the information providing unit 806 and information configuring unit 805 shown in FIG. 8 may be included in FIG. 9, and so on and so forth, which shall not be described any further.

It can be seen from the above embodiment that when a user purchases part of video contents of a complete video file, if the user has also purchased another part of video contents of the video file, the server may combine this part of video contents with the part of video contents that has already been purchased, and update the authorization control information at the same time.

In this embodiment, the user may acquire, via a network, the corresponding relationship between the played time and the price of the video file from the server, by using such client as a mobile phone, and a notebook computer, etc., and select the video contents as needed according to the corresponding relationship, as shown in FIG. 2.

FIG. 10 is a schematic diagram of the structure of the client in accordance with embodiment 9 of the present invention. As shown in FIG. 10, the client includes: a first information acquiring unit 1001 and a request transmitting unit 1002.

The first information acquiring unit 1001 is used for acquiring time information of a complete video file, the time information being corresponding relationship between the played time and price of the video file. The request transmitting unit 1002 is used for transmitting to a server a purchasing request, including the starting time and the ending time of part of video contents in the complete video file, selected by a user.

Furthermore, the client includes a receiving unit 1003 for receiving the video file and the authorization control information generated by the server; wherein the video file is the part of video contents selected by the user corresponding to the starting time and the ending time, and the contents contained in the authorization control information are as described in the above embodiment, which shall not be described any further.

After obtaining the video file and authorization control information, the client may play the video file. Furthermore, at the server side, the video file and authorization control information may also be stored in such carriers as a CD for providing to the user, and the user may play the video file with a playing device, such as a DVD.

If the purchased video file is a 3D video file, the client may further include a purchasing unit for authorization for playing 3D (not shown), for transmitting a request to the server for purchase authorization for playing 3D, and after the user makes payment, the server may add identification information indicating that 3D effect may be played in the authorization control information.

FIG. 11 is a schematic diagram of the structure of the video playing device in accordance with embodiment 10 of the present invention. As shown in FIG. 11, the device includes a first reading unit 1101, a second judging unit 1102, and a first transmitting unit 1103.

The first reading unit 1101 is used for reading a video file, wherein the video contents contained in the video file being part of video contents in a complete video file. The second judging unit 1102 is used for judging whether the video file has been purchased according to the video identification of the video file and the pre-obtained authorization control information, wherein the authorization control information includes a video identification and the starting time and the ending time of the video file, as well as other information as described in the above embodiment, which shall not described any further. The first transmitting unit 1103 is used for transmitting video signals to a displaying unit if the result of judgment of the second judging unit 1102 is positive, such that the displaying unit plays the video file.

Furthermore, as shown in FIG. 11, the device further includes a displaying unit 1104 for receiving the video signals transmitted by the first transmitting unit 1103 and displaying the corresponding video. The displaying unit 1104 is optional, since the video playing device may display the video contents by connecting to a displaying device via a port and a line.

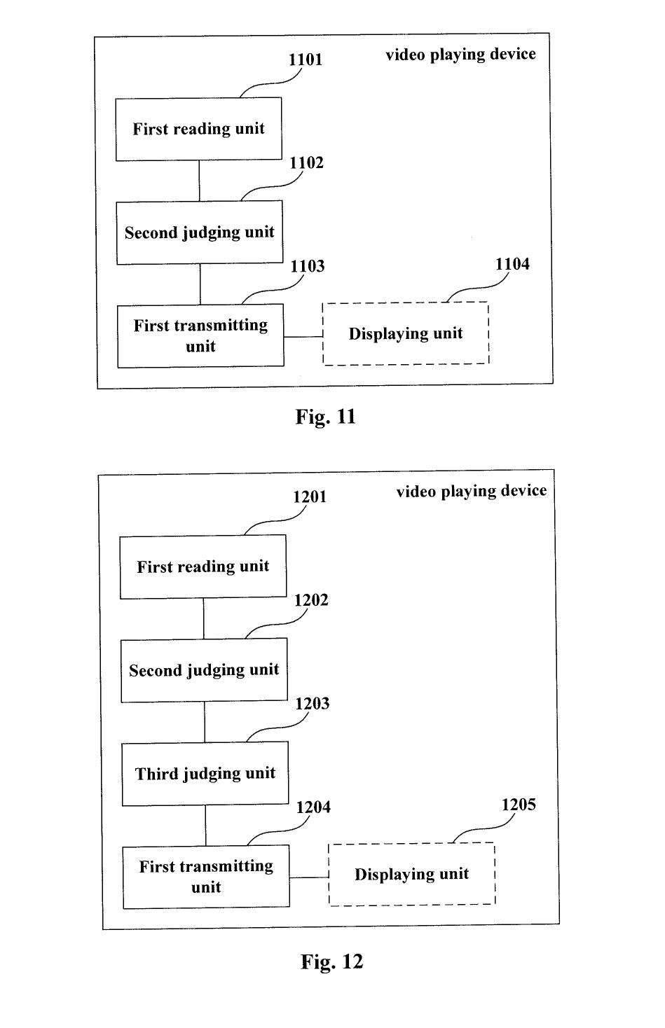

In this embodiment, the video file may be a 3D video file, and the authorization control information further includes identification information indicating whether a 3D effect can be played. Thus, when the video playing device plays the 3D video file, it may include, in addition to the elements shown in FIG. 11, other parts, as shown in FIG. 12.

FIG. 12 is a schematic diagram of the structure of the video playing device in accordance with embodiment 11 of the present invention. As shown in FIG. 12, the device includes a first reading unit 1201, a second judging unit 1202, a first transmitting unit 1204 and a displaying unit 1205, with the functions of which being similar to those described in embodiment 10 shown in FIG. 11, which shall not be described any further.

As shown in FIG. 12, the device further includes a third judging unit 1203, wherein the third judging unit 1203 is used for judging whether authorization for playing 3D has been purchased according to the identification information, if the result of judgment of the second judging unit 1202 is positive. The first transmitting unit 1204 transmits video signals to the displaying unit, if the result of judgment of the third judging unit 1203 is positive, such that the displaying unit plays video with 3D effect, and transmits video signals to the displaying unit, if the result of judgment of the third judging unit 1203 is negative, such that the displaying unit plays video with 2D effect.

In the above embodiment, the displaying unit 1205 is optional.

It can be seen from the above embodiment that only when the user purchases 3D video from the video provider and the identification information contained in the authorization control information indicates that 3D effect may be played, video with 3D effect may be played. Otherwise, only video with 2D effect may be played.

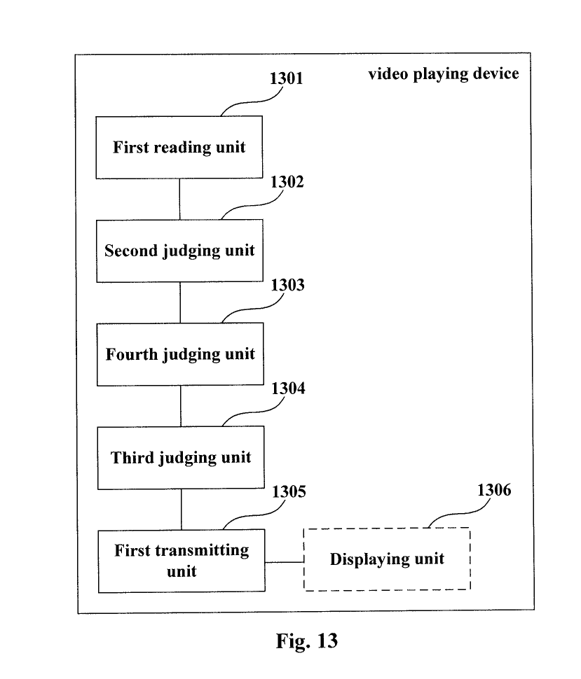

FIG. 13 is a schematic diagram of the structure of the video playing device in accordance with embodiment 12 of the present invention. As shown in FIG. 13, the device includes a first reading unit 1301, a second judging unit 1302, a third judging unit 1304, a first transmitting unit 1305 and a displaying unit 1306, with the functions of which being similar to those described in embodiment 11 shown in FIG. 12, which shall not be described any further.

As shown in FIG. 13, the device further includes a fourth judging unit 1303 used for judging whether the displaying unit 1306 supports 3D video, if the result of judgment of the second judging unit 1302 is positive. The third judging unit 1304 judges whether video with 3D effect may be played, if the result of judgment is that 3D video is supported.

In the above embodiment, the displaying unit 1306 is optional.

It can be seen from the above embodiment that only when the user purchases 3D video from the video provider and the displaying unit supports 3D video and the identification information contained in the authorization control information indicates that 3D effect may be played, video with 3D effect may be played. Otherwise, only video with 2D effect may be played.

In the above embodiment, the video playing device may be any device having a function of playing video, such as a computer, a mobile phone, and a DVD, etc. Furthermore, the video playing device may be realized, together with the client shown in FIG. 10, by one device, that is, it can not only purchase the video file to obtain the authorization control information, but also play the video file. Every component of the video playing device may be realized by hardware, firmware, software, or combinations thereof, without departing from the scope of the present invention.

In the embodiments of the present invention, for a 3D video file, a video playing method is also provided, in which the playing device can play video with 3D effect only after authorization for playing 3D is obtained. Otherwise, only video of 2D can be played.

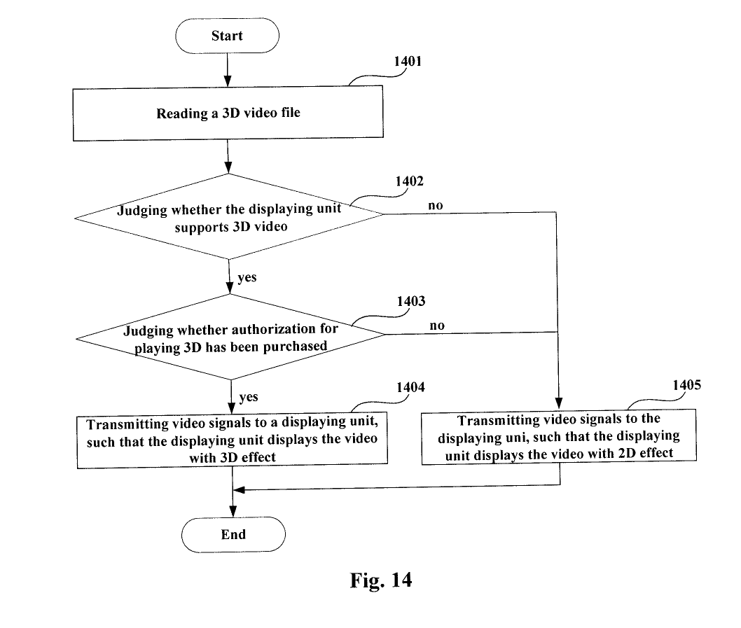

FIG. 14 is a flowchart of the video playing method in accordance with embodiment 13 of the present invention. As shown in FIG. 14, the method includes:

Step 1401: reading a 3D video file by a playing device.

Step 1402: judging whether the displaying unit of the video file supports 3D video; executing step 1403, if the result of judgment is positive and executing step 1405, if the result of judgment is negative.

Step 1403: judging whether authorization for playing 3D has been purchased according to the video identification of the 3D video file and the pre-obtained authorization control information, when the result of judgment in step 1402 is that 3D video is supported.

In this embodiment, if the user has purchased authorization for playing 3D video file via a network and obtains authorization control information, the authorization control information contains identification information indicating that 3D effect may be played. For example, if the identification information is “1”, it indicates that a video file with 3D effect may be played. If the 3D video file is not purchased, the identification information is “0”, indicating that only a video file with 2D effect may be played.

Step 1404: transmitting video signals to a displaying unit if the result of judgment in step 1403 is positive, such that the displaying unit displays the video with 3D effect; and

Step 1405: transmitting video signals to the displaying unit if the result of judgment in steps 1402 and 1403 is negative, such that the displaying unit displays the video with 2D effect. In this embodiment, in a case where the playing device supports 3D video, or a displaying unit connected to the playing device supports 3D video, step 1402 may be optional.

In this embodiment, the above playing device may be any terminal equipment having a function supporting 3D video file playing, such as a mobile phone, a computer, and a DVD, etc.

Furthermore, when the user uses the playing device to purchase a 3D video file, the method further includes: transmitting a request for purchasing the 3D video to a server via a network and receiving authorization control information returned by the server, including the video identification of the 3D video file and identification information indicating whether a 3D effect can be played. Furthermore, a returned video file may be received.

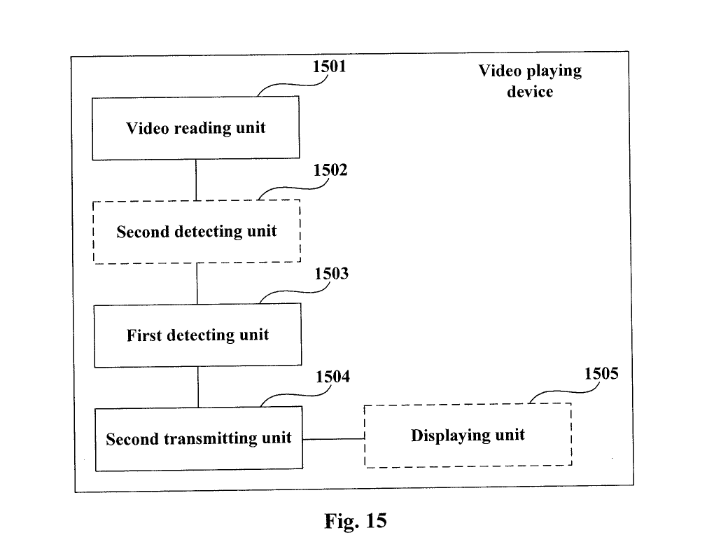

FIG. 15 is a schematic diagram of the structure of the video playing device in accordance with embodiment 14 of the present invention. As shown in FIG. 15, the device includes: a video reading unit 1501, a second detecting unit 1502, a first detecting unit 1503, and a second transmitting unit 1504.

The video reading unit 1501 is used for reading a 3D video file. The second detecting unit 1502 is used for judging whether the displaying unit connected to the playing device supports 3D video. The first detecting unit 1503 is used for judging whether to purchase the authorization for playing 3D according to the video identification of the 3D video file and pre-obtained authorization control information. The second transmitting unit 1504 is used for transmitting video signals to the displaying unit if the result of judgment of the first detecting unit 1503 is positive, such that the displaying unit displays the video with 3D effect and transmitting video signals to the displaying unit if the result of judgment is negative, such that the displaying unit displays the video with 2D effect.

The second detecting unit 1502 is optional.

In this embodiment, the video playing device further includes a displaying unit 1505 for displaying video with 3D effect or 2D effect according to the video signals transmitted by the second transmitting unit 1504. For such a player as a DVD, the displaying unit 1505 need not be included and is optional.

In the embodiment of the present invention, the device further includes a request transmitting unit and an information acquiring unit (not shown), wherein the request transmitting unit is used for transmitting a request for purchasing the 3D video to a server via a network and the information acquiring unit is used for acquiring authorization control information returned by the server in response to the request, including the video identification of the 3D video file and identification information indicating whether a 3D effect can be played.

In this embodiment, the user may make request for purchasing a 3D video file via his client or directly via a server provided by the provider, and the server may generate the corresponding authorization control information according to the request.

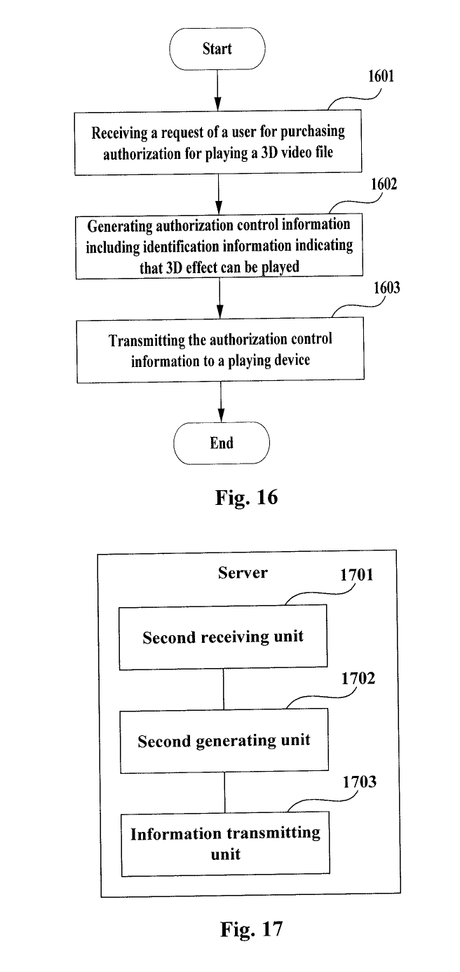

FIG. 16 is a flowchart of the video purchasing method in accordance with embodiment 15 of the present invention. As shown in FIG. 16, the method includes:

Step 1601: receiving a request of a user for purchasing authorization for playing a 3D video file.

In this embodiment, the user may transmit a request for purchasing authorization for playing a 3D video file to a server via his client, or input a request for purchasing authorization for playing a 3D video file into a server of a provider.

In this embodiment, the client may be a video playing device.

Step 1602: generating, after the user purchases the 3D video file, the authorization control information including identification information indicating that 3D effect can be played; and

Step 1603: transmitting the authorization control information to a playing device.

FIG. 17 is a schematic diagram of the structure of the server in accordance with embodiment 16 of the present invention. As shown in FIG. 17, the server includes a second receiving unit 1701, a second generating unit 1702, and an information transmitting unit 1703.

The second receiving unit 1701 is used for receiving a request of a user for purchasing authorization for playing a 3D video file. The second generating unit 1702 is used for generating, after the user purchases the 3D video file, the authorization control information including video identification and identification information indicating that 3D effect can be played and the information transmitting unit 1703 is used for transmitting the authorization control information to a playing device.

It can be seen from the above embodiment that only when the user purchases 3D video from the video provider and the identification information contained in the authorization control information indicates that 3D effect may be played, video with 3D effect may be played. Otherwise, only video with 2D effect may be played.

Features that are described and/or illustrated above with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

The above devices and methods of the present invention may be implemented by hardware, and may also be implemented by hardware in combination with software. The present invention relates to such a computer-readable program that when the program is executed by a logic component, it enables the logic component to implement the devices or constitutional parts as described above, or enables the logic component to implement the methods or steps as described above. The present invention relates also to a storing medium for storing the above program, such as a hard disk, a floppy disk, a CD (such as a Blue Ray CD, and a DVD, etc.), and flash memory, etc.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

1. A video purchasing method, comprising:
receiving a request of a user for purchasing a video file, the request including a starting time and an ending time of a part of the video contents in a complete video file selected by the user;
determining a starting frame and an ending frame to which the starting time and the ending time correspond; and
generating the video file to which the part of the video contents corresponds according to the starting frame and the ending frame.

2. The method according to claim 1, wherein the method further comprises: generating corresponding authorization control information;
the authorization control information including at least one of:
identification of the generated video file, and, the starting frame and the ending frame of the generated video file; or
control information of the whole video file and the control information of the generated video file;
the control information of the generated video file comprising:
the identification of the generated video file, the starting frame and the ending frame of the generated video file and the following information: the type of the playing license of the generated video file, limitation and the link information directed to the control information of the whole video file.

3. The method according to claim 1, wherein before receiving a request of a user for purchasing a video file,
configuring a complete video file with frame identifications and corresponding prices frame by frame; and
generating the video file to according to the frame identifications in an increasing order to which the starting frame and the ending frame correspond.

4. The method according to claim 3, wherein the method further comprises:
providing the time information of the complete video file according to the request of the user, such that the user selects the starting time and the ending time of the part of the video contents according to the time information, wherein
the time information is corresponding relationship between the played time and price of the video file.

5. The method according to claim 2, wherein after the step of receiving a request of a user for purchasing a video file, the method further comprises:
judging whether the user has purchased other parts of the video contents of the complete video file;
adding the part of the video contents selected by the user to the video file to which the other parts of the video contents correspond, if the result of judgment is positive; and
updating the authorization control information.

6. The method according to claim 2, wherein the video file is a 3D video file, and the authorization control information further comprises identification information indicating whether a 3D effect can be played.

7. A video purchasing method, comprising:
acquiring time information of a complete video file, the time information being corresponding relationship between the played time and price of the video file; and
transmitting to a server a request for purchasing including a starting time and an ending time of part of video contents in the complete video file, selected by a user.

8. A video playing method, comprising:
reading a video file, the video contents contained in the video file being part of video contents in a complete video file;
judging whether the video file has been purchased according to a video identification of the video file and pre-obtained authorization control information;
wherein the authorization control information comprises the video identification and a starting time and an ending time of the video file; and
transmitting video signals to a displaying unit if the result of judgment is positive, such that the displaying unit plays the video file.

9. The method according to claim 8, wherein the video file is a 3D video file, and the authorization control information further comprises identification information indicating whether a 3D effect can be played; and
before the step of transmitting video signals to the displaying unit, the method further comprises:
judging whether authorization for playing 3D has been purchased; transmitting video signals to the displaying unit if the result of judgment is positive, such that the displaying unit plays the video with 3D effect; and transmitting video signals to the displaying unit if the result of judgment is negative, such that the displaying unit plays the video with 2D effect.

10. The method according to claim 9, wherein before the step of judging whether authorization for playing 3D has been purchased, the method further comprises:
judging whether the displaying unit supports 3D video; and
if the result of judgment is that the displaying unit supports 3D video, judging whether authorization for playing 3D has been purchased.

11. A server, comprising:
a first receiving unit, for receiving a request of a user for purchasing a video file, the request including starting time and ending time of part of the video contents in a complete video file selected by the user;
a first determining unit, for determining a starting frame and an ending frame to which the starting time and the ending time correspond; and
a first generating unit, for generating the video file to which the part of the video contents corresponds according to the starting frame and the ending frame.

12. The server according to claim 11, wherein the server further comprises:
an information generating unit, for generating corresponding authorization control information, wherein the authorization control information including at least one of
the identification of the generated video file and the starting frame and ending frame of the generated video file; or
control information of the whole video file and the control information of the generated video file; wherein
the control information of the generated video file comprises:
the identification of the generated video file, the starting frame and ending frame of the generated video file, and the following information: the type of the playing license of the generated video file, limitation and the link information directed to the control information of the whole video file.

13. The server according to claim 11, wherein the server further comprises:
an information configuring unit, for configuring a complete video file with frame identifications and corresponding prices frame by frame; wherein
the first generating unit is used for generating the video file to which the part of the video contents corresponds according to the frame identifications in an increasing order to which the starting frame and the ending frame correspond.

14. The server according to claim 13, wherein the server further comprises:
an information providing unit, for providing the time information of the complete video file according to the request of the user, such that the user selects the starting time and the ending time of the part of the video contents according to the time information; wherein
the time information is corresponding relationship between the played time and price of the video file.

15. The server according to claim 12, wherein the server further comprises:
a first judging unit, for judging whether the user has purchased other parts of the video contents of the complete video file;
a second generating unit, for adding the part of the video contents selected by the user to the video file to which the other parts of the video contents correspond, if the result of judgment of the first judging unit is positive; and
an information updating unit, for updating the authorization control information.

16. The server according to claim 12, wherein the video file is a 3D video file, and the authorization control information further comprises identification information indicating whether a 3D effect can be played.

17. A client, comprising:
a first information acquiring unit, for acquiring time information of a complete video file, the time information being corresponding relationship between the played time and price of the video file; and
a request transmitting unit, for transmitting to a server a request for purchasing, including a starting time and an ending time of part of video contents in the complete video file, selected by a user.

18. A video playing device, comprising:
a first reading unit, for reading a video file, the video contents contained in the video file being part of video contents in a complete video file;
a second judging unit, configured to judge whether the video file has been purchased according to the video identification of the video file and pre-obtained authorization control information; wherein the authorization control information comprises a video identification and the starting time and ending time of the video file; and
a first transmitting unit, for transmitting video signals to a displaying unit if the result of judgment of the second judging unit is positive, such that the displaying unit plays the video file.

19. The device according to claim 18, wherein the device further comprises a displaying unit, for receiving the video signals transmitted by the first transmitting unit and displaying corresponding video.

20. The device according to claim 18, wherein the video file is a 3D video file, and the authorization control information further comprises identification information indicating whether a 3D effect can be played; and
the device further comprises:
a third judging unit, for judging whether authorization for playing 3D has been purchased when the result of judgment of the second judging unit is positive; and
when the result of judgment of the third judging unit is positive, the first transmitting unit transmits video signals to the displaying unit, such that the displaying unit plays the video with 3D effect; and
when the result of judgment of the third judging unit is negative, transmits video signals to the displaying unit, such that the displaying unit plays the video with 2D effect.

21. The device according to claim 20, wherein the device further comprises a fourth judging unit, for, before the third judging unit judges whether authorization for playing 3D has been purchased, judging whether the displaying unit supports 3D video; and when the result of judgment is that the displaying unit supports 3D video, the third judging unit judges whether video with 3D effect can be played.

22. A video playing method, comprising:
reading a 3D video file;
judging whether authorization for playing 3D has been purchased according to the video identification of the 3D video file and pre-obtained authorization control information; and
transmitting video signals to a displaying unit if the result of judgment is positive, such that the displaying unit displays the video with 3D effect; and transmitting video signals to the displaying unit if the result of judgment is negative, such that the displaying unit displays the video with 2D effect.

23. The method according to claim 22, wherein after a playing device reads a 3D video file, the method further comprises:
judging whether the displaying unit supports 3D video;
judging whether authorization for playing 3D has been purchased, if the result of judgment is that the displaying unit supports 3D video.

24. The method according to claim 22, wherein the method further comprises:
transmitting a request for purchasing the 3D video to a server via a network; and
receiving authorization control information returned by the server in response to the request, including the video identification of the 3D video file and identification information indicating whether a 3D effect can be played.

25. A video playing device, comprising:
a video reading unit, for reading a 3D video file;
a first detecting unit, for judging whether authorization for playing 3D has been purchased according to the video identification of the 3D video file and pre-obtained authorization control information; and
a second transmitting unit, for transmitting video signals to a displaying unit if the result of judgment of the first detecting unit is positive, such that the displaying unit displays the video with 3D effect; and transmitting video signals to the displaying unit if the result of judgment is negative, such that the displaying unit displays the video with 2D effect.

26. The device according to claim 25, wherein the device further comprises a displaying unit, for displaying video with 3D effect or 2D effect according to the video signals transmitted by the second transmitting unit.

27. The device according to claim 25, wherein the device further comprises:
a second detecting unit, for judging whether the displaying unit supports 3D video;
the first detecting unit judges whether authorization for playing 3D has been purchased when the result of the second detecting unit is that the displaying unit supports 3D video.

28. The device according to claim 25, wherein the device further comprises:
a request transmitting unit, for transmitting a request for purchasing the 3D video to a server via a network; and
an information acquiring unit, for acquiring authorization control information returned by the server in response to the request, including the video identification of the 3D video file and identification information indicating whether a 3D effect can be played.

29. A video purchasing method, comprising:
receiving a request of a user for purchasing a 3D video file;
generating, after the user purchases the 3D video file, authorization control information including identification information indicating that 3D effect can be played; and
transmitting the authorization control information to a playing device.

30. A server, comprising:
a second receiving unit, for receiving a request of a user for purchasing a 3D video file;
a second generating unit, for generating, after the user purchases the 3D video file, authorization control information including video identification and identification information indicating that 3D effect can be played; and
an information transmitting unit, for transmitting the authorization control information to a playing device.
